(19) United States
(12) Patent Application Publication
(10) Pub. No.: US 2008/0292744 A1
(43) Pub. Date: Nov. 27, 2008

(54) Mold a secondary molding

(76) Inventors: Chih-Yu Chen, Tu-Cheng City (TW); Jian-Ren Wang, Tu-Cheng City (TW); Xiao-Jun Zheng, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/802,272

(22) Filed: May 22, 2007

(51) Int. Cl. B29C 45/42

(52) U.S. Cl. 425/444

(57) ABSTRACT

A mold for a secondary molding includes a lower mold insert, an upper mold insert coupled to the lower mold insert, and an extraction device loaded in the lower mold insert. The lower mold insert has a lower container, a couple of lower notches adjacent to the two opposite sides of the lower container respectively and a lower cavity with two opposite sides connected to the lower notches respectively. The extraction device has an inserting core. The inserting core includes a body with two molding portions at its opposite sides. The body is inserted into the lower container, the molding portions project into the lower cavities.

### BACKGROUND OF THE INVENTION

1. Field of the Invention

This invention generally relates to a mold, and more particularly to a mold for a secondary molding.

2. The Related Art

A conventional mold for a secondary molding includes an upper mold insert, a lower mold insert and a cavity formed between the upper mold insert and the lower mold insert. A primary product made from the liquid plastic is placed in the cavity, then the upper mold insert and the lower mold insert join together to achieve the secondary molding, the upper mold insert is separated with the lower mold insert when a molded article is cooled into solid position and a driving pin mounted in the mold pushes the plastic product out of the mold to finalize the extraction of the molded article. If the primary product placed in the mold is small, the process of insertion is difficult and time-consuming. As same as the insertion, the process of extraction of the molded article by the driving pin is uneasy. Meanwhile, the driving pin may damage the molded article.

Thus, it would be desirable to provide a mold for a secondary molding which overcomes the problems encountered with the conventional mold for a secondary molding.

### SUMMARY OF THE INVENTION

An object of the present invention is to provide a mold for a secondary molding to achieve the extraction of a molded article quickly and reliably.

To achieve the former object, the mold for a secondary molding includes a lower mold insert, an upper mold insert coupled to the lower mold insert and an extraction device loaded in the lower mold insert. The lower mold insert has a lower container, a couple of lower notches adjacent to the two opposite sides of the lower container respectively and a lower cavity with two opposite sides connected to the lower notches respectively. The extraction device has an inserting core inserted into the lower container. The inserting core includes a body with two molding portions at the opposite sides. The body is received in the lower container, the molding portion projects into the lower cavity.

As described above, the primary product is loaded around the molding portion of the inserting core and then placed in the lower mold insert to achieve the secondary molding. After molding, the molded article is extracted by pulling of the inserting core and then is unloaded from the inserting core. This mold for a secondary molding has a simple and low cost construction, and the method for using the mold for a secondary molding is simplified, so the molded article can be extracted quickly and reliably.

### BRIEF DESCRIPTION OF THE DRAWINGS

A detailed explanation of a preferred embodiment of the present invention will be given, with reference to the attached drawings, for better understanding thereof to those skilled in the art:

FIG. 1 is an exploded view of a mold for a secondary molding accordance to the present invention;

FIG. 2 is a perspective view of an upper mold insert of the mold for a secondary molding according to the present invention;

FIG. 3 is a perspective view of a lower mold insert of the mold for a secondary molding according to the present invention;

FIG. 4 is a perspective view of an inserting core of the mold for a secondary molding according to the present invention;

FIG. 5 is another perspective view of an inserting core of the mold for a secondary molding according to the present invention;

FIG. 6 is a perspective view of a handle of an extraction device shown in FIG. 1;

FIG. 7 is an exploded view of the extraction device of the mold for a secondary molding according to the present invention;

FIG. 8 is a perspective view of the extraction device of the mold for a secondary molding according to the present invention;

FIG. 9 is a cross-sectional view of the handle inserted into the inserting core;

FIG. 10 is a cross-sectional view of two pulling blocks of the handle abutting against the inserting core;

FIG. 11 is a perspective view of the inserting core, with two primary products placed on the inserting core;

FIG. 12 is a perspective view showing the inserting core with the molded article located in the lower mold insert and the handle being inserted into the inserting core;

FIG. 13 is a perspective view showing the inserting core with the molded article extracted from the lower mold insert by pulling of the handle; and

FIG. 14 is a perspective view of the molded article.

### DETAILED DESCRIPTION OF THE PREFERRED EMBODIMENT

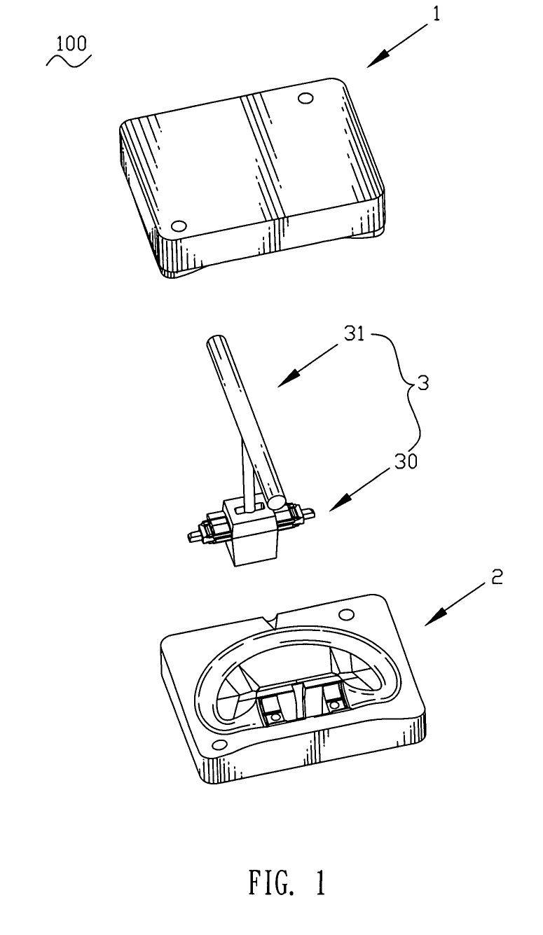

Referring to FIG. 1, a mold for a secondary molding 100 comprises an upper mold insert 1, a lower mold insert 2 and an extraction device 3. The extraction device 3 has an inserting core 30 and a handle 31 that can be inserted into the inserting core 30 in order to extract the inserting core 30.

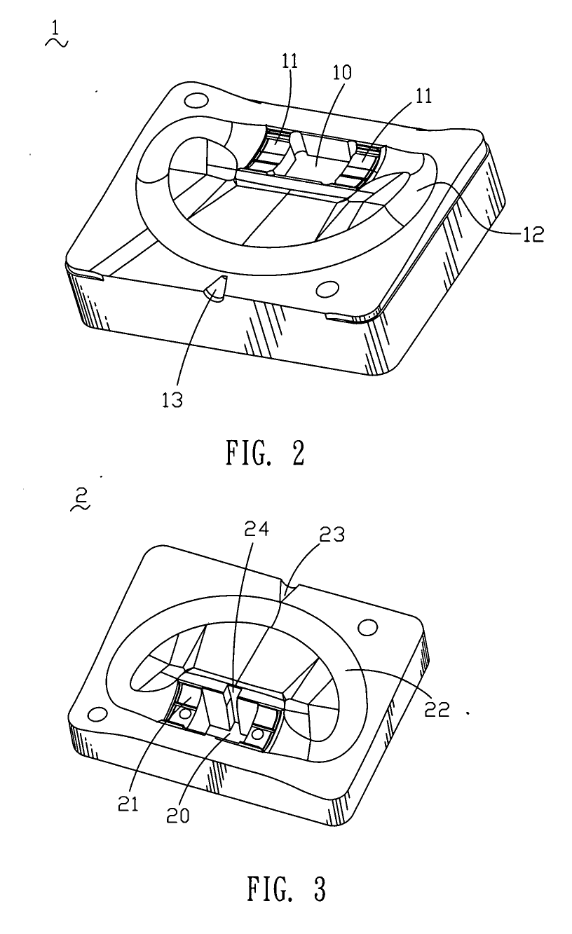

With reference to FIG. 2, the upper mold insert 1 defines an upper container 10 at the bottom surface and a couple of upper notches 11 adjacent to the two opposite sides of the upper container 10 respectively. An upper cavity 12 is formed as an arc. Two ends of the upper cavity 12 are connected to the upper notches 11 respectively. The upper mold insert 1 defines an upper sprue hole 13 with one end connected to the upper cavity 12 and the other end extending outwardly therethrough.

With reference to FIG. 3, the lower mold insert 2 coupled to the upper mold insert 1 defines a lower container 20 at the top surface, and a couple of lower notches 21 adjacent to the two opposite sides of the lower container 20 respectively. A lower cavity 22 is formed as an arc. Two opposite sides of the lower cavity 22 are connected to the lower notches 21 respectively. The lower mold insert 2 has a lower sprue hole 23 with one end connected to the lower cavity 22 and the other end extending outwardly therethrough. The upper sprue hole 13 and the lower sprue hole 23 cooperate with each other to define a sprue gate for injecting into the molten plastic. An upright through slot 24 is defined in an end surface of the lower container 20 and passes through the top of the lower mold insert 2.

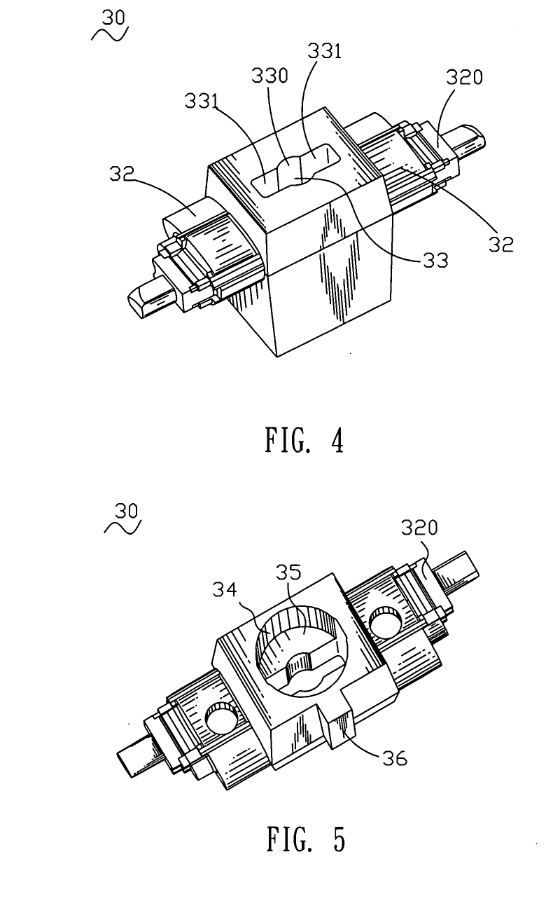

With reference to FIG. 4 and FIG. 5, the inserting core 30 has a body 31 and two arms 32 extending from its opposite sides. A through hole 33 is defined in the top surface of the body 31 and comprises a curved hole 330 and two linearity holes 331 adjacent to the two opposite sides of the curved hole 330. The through hole 33 ends at the inner of the body 31. A columned receiving hole 34 is defined in a lower part of the body 31 and communicates with the through hole 33. The diameter of the receiving hole 34 is approximately equivalent to the length of the through hole 33, the through hole 33 is at the middle of the receiving hole 34, so a shoulder 35 is formed at the communicating place of the through hole 33 and the receiving hole 34. A sliding beam 36 extends outwardly from the lateral side of the body 31. Each arm 32 defines a molding portion 320 at the end.

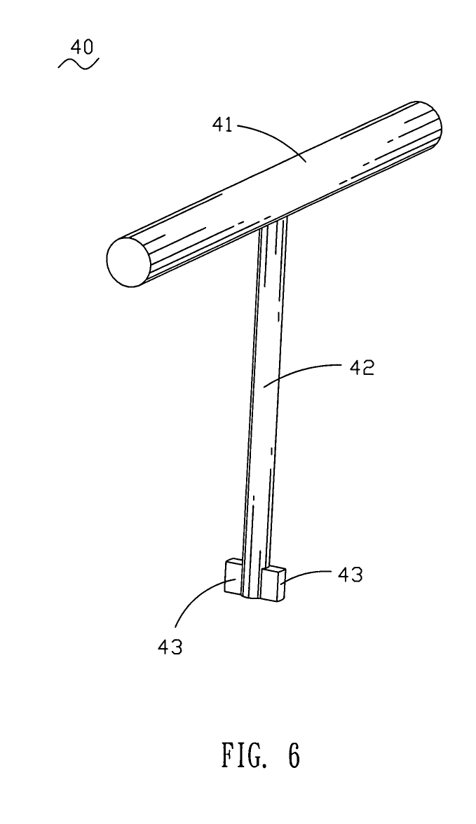

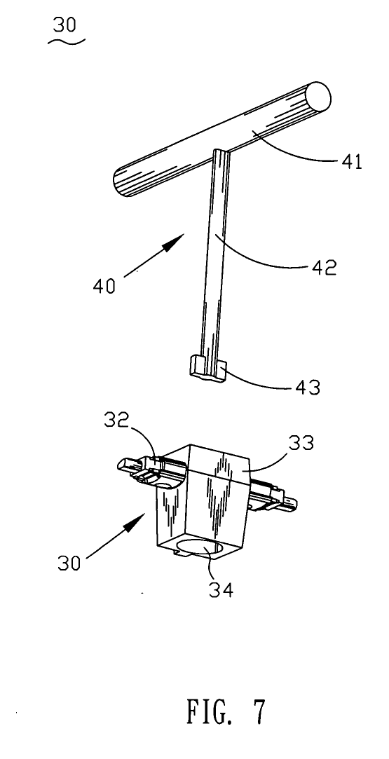

With reference to FIG. 6 and FIG. 7, the handle 40 includes a lug 41, a connecting bar 42 extending downward from the middle of the lug 41 and two pulling blocks 43 symmetrically extending outward from the opposite sides of the bottom of the connecting bar 22. The pulling blocks 43 and the bottom of the connecting bar 42 are similar to the shape of the through hole 33, which are inserted into the through hole 33 and then the receiving hole 34 and can rotate in the receiving hole 34.

The novel features of the present are set forth, the assembly and use of the present invention will be understood from following description.

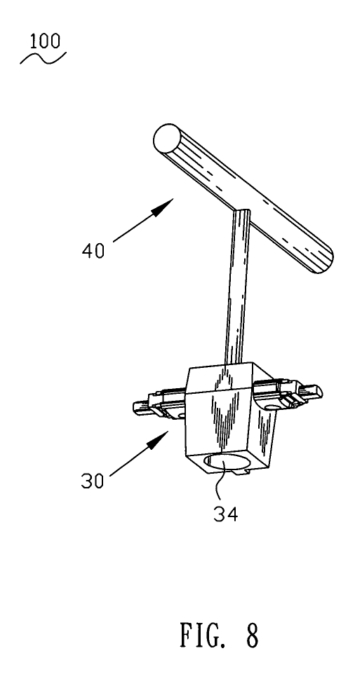

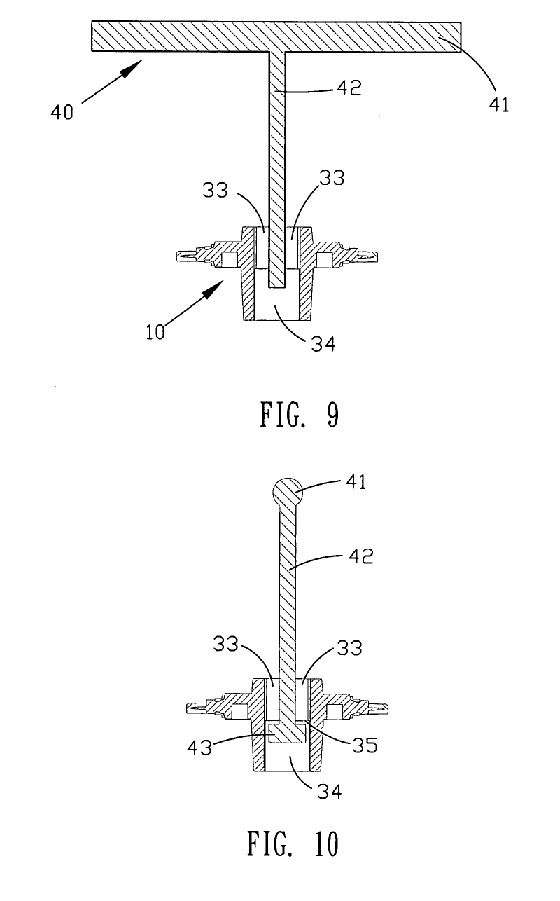

The inserting core 30 is installed in a container formed by the lower container 20 and the upper container 10, and the arms 12 is installed among the notches 11, 21. The molding portions 320 stretch into the cavities 12, 22. The sliding beam 36 is slidingly upward and downward along the through slot 24. The handle 40 can extract the inserting core 30 out of the mold for a secondary molding 100. In use, the pulling blocks 43 and the connecting bar 42 stretch downward along the through hole 33 until the pulling blocks 43 is totally received in the receiving hole 34. The pulling blocks 43 rotates a certain degree to abut against the shoulder 35, then the inserting core 30 moves outwardly following the trail of the pulling blocks 43 (shown in FIGS. 8-10).

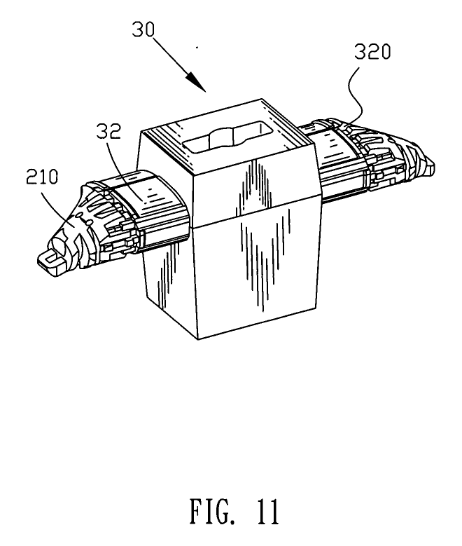

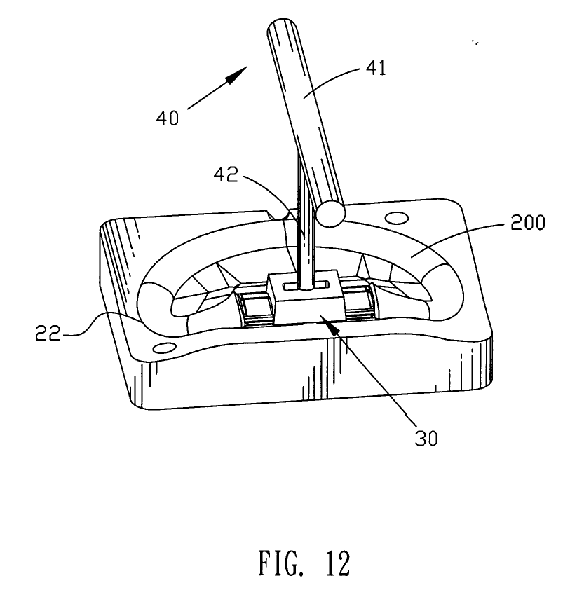

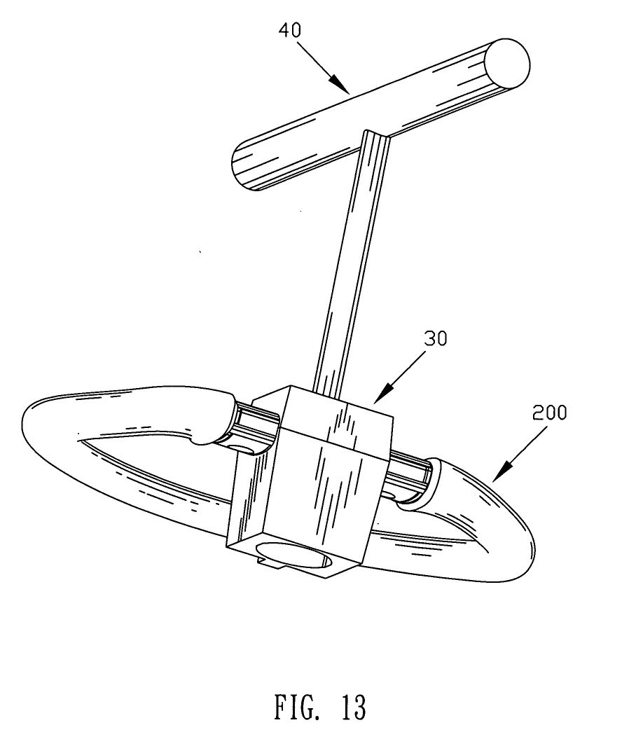

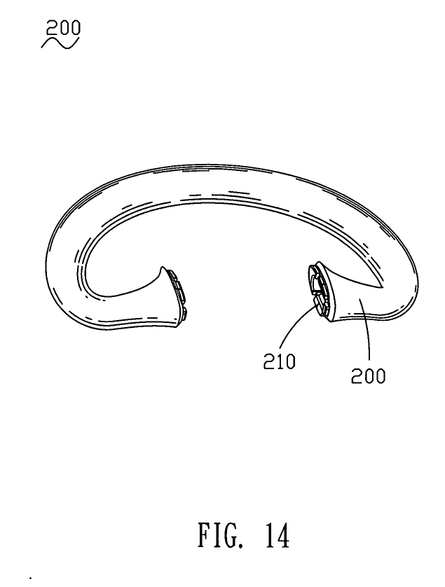

The following description will illustrate the process of the molding. The mold for a secondary molding 100 is used for producing a molded article 200 (shown in FIGS. 13-14), in the embodiment, which is an ear-hook. Referring to FIG. 11 and FIG. 12, the molding portions 320 of the inserting core 30 loaded with primary products 210 are placed between two ends of the cavities 12, 22 to achieve secondary molding. The molded article 200 is extracted out of the mold for a secondary molding 100 following the inserting core 30 after molding.

The following description is detailed description of a method for using the mold for a secondary molding:
first, place the primary products 210 around the corresponding molding portions 320, and insert the body 31 into the lower container 20 of the lower mold insert 2;
join the upper mold insert 1 and the lower mold insert 2 together for a secondary molding thereby to form the molded article 200;
separate the upper mold insert 1 from the lower mold insert 2 when the molded article 200 is cooled into solid position;
withdraw the inserting core 30 from the lower mold insert 2;
unload the molded article 200 loaded in the molding portions 320 from the inserting core 30 to achieve extraction thereby.

As described above, the primary product 210 is loaded around the molding portions 320 of the inserting core 30 and then placed in the lower mold insert 2 to achieve the secondary molding. After molding, the molded article 200 is extracted by pulling of the inserting core 30 and then is unloaded from the inserting core 30. This mold for a secondary molding 100 has a simple and low cost construction, and the method for using the mold for a secondary molding 100 is simplified, so the molded article can be extracted quickly and reliably.

What is claimed is:

1. A mold for a secondary molding, comprising:
a lower mold insert having a lower container and a lower cavity with two opposite sides connected to the lower container respectively;
an extraction device having an inserting core, said inserting core including a body with two arms at its opposite sides, two molding portions extending from the ends of the arms, said body being inserted into the lower container, said molding portions projecting into the lower cavity; and
an upper mold insert coupled to the lower mold insert.

2. The mold for a secondary molding according to claim 1, wherein said lower mold insert has an upright through slot defined in an end surface of the lower container and passing through the top of the lower mold insert, said body having a sliding beam extending outwardly from the lateral side of the body, the sliding beam being sliding in upward and downward direction along the through slot.

3. The mold for a secondary molding according to claim 1, wherein the upper mold insert has an upper container and an upper cavity matching with the lower container and the lower cavity respectively, upper part of the inserting core is received in the upper container.

4. The mold for a secondary molding according to claim 1, wherein the extraction device further comprises a handle which includes a lug, a connecting bar extending downward from the middle of the lug, and two pulling blocks located at the opposite sides of the bottom of the connecting bar, the top surface of the body defining a through hole therein, the through hole ending at the inner of the body, a receiving hole defined in a lower part of the body and communicating with the through hole, the through hole being in the middle of the receiving hole, so a shoulder is formed at the communicating place of the through hole and the receiving hole, the pulling blocks being inserted into the through hole with the receiving hole rotating in the receiving hole.
